(19) United States
(12) Patent Application Publication
(10) Pub. No.: US 2009/0020522 A1
(43) Pub. Date: Jan. 22, 2009

(54) Micro-heaters and methods for manufacturing the same

(75) Inventors: Andrei Zoulkarneev, Suwon-si (KR); Junhee Choi, Seongnam-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/149,884

(22) Filed: May 9, 2008

(30) Foreign Application Priority Data
Jul. 16, 2007 (KR) 10-2007-0071341

(51) Int. Cl. H01C 17/00; H05B 3/44

(52) U.S. Cl. 219/544; 29/610.1

(57) ABSTRACT

Example embodiments provide a micro-heater including, a substrate, at least one heating element unit provided on the substrate, the at least one heating element unit having a configuration to allow two or more heating element units to be repeatedly connected in series, and a support structure between the substrate and the at least one heating element unit to support the at least one heating element unit at a lower part of the at least one heating element unit. Example embodiments also provide a method for manufacturing a micro-heater including forming a sacrificial layer on a substrate and forming a heating element layer on the sacrificial layer, patterning the heating element layer to form at least one heating element unit, wherein the at least one heating element unit has a configuration to allow two or more heating element units to be repeatedly connected in series, etching the sacrificial layer to form a support structure to support the at least one heating element unit at a lower part of the at least one heating element unit.

### PRIORITY STATEMENT

This application claims priority under 35 U.S.C. §119 to Korean Patent Application No. 10-2007-0071341, filed on Jul. 16, 2007, in the Korean Intellectual Property Office, the entire contents of which are incorporated herein by reference.

### BACKGROUND

1. Field

Example embodiments relate to micro-heaters and methods for manufacturing the same.

2. Description of the Related Art

A micro-heater locally generates high temperature heat on a substrate when electric power is applied to the micro-heater. A micro-heater may be used for a variety of electronic devices, which require high temperature manufacturing or operating processes, for example, carbon nanotube transistors, low temperature polysilicon or thin film transistors.

### SUMMARY

Example embodiments provide a micro-heater including, a substrate, at least one heating element unit provided on the substrate, the at least one heating element unit having a configuration to allow two or more heating element units to be repeatedly connected in series, and a support structure between the substrate and the at least one heating element unit to support the at least one heating element unit at a lower part of the at least one heating element unit. Example embodiments also provide a method for manufacturing a micro-heater including forming a sacrificial layer on a substrate and forming a heating element layer on the sacrificial layer, patterning the heating element layer to form at least one heating element unit, wherein the at least one heating element unit has a configuration to allow two or more heating element units to be repeatedly connected in series, etching the sacrificial layer to form a support structure to support the at least one heating element unit at a lower part of the at least one heating element unit.

### BRIEF DESCRIPTION OF THE DRAWINGS

Example embodiments will be more clearly understood from the following detailed description taken in conjunction with the accompanying drawings. FIGS. 1-4 represent non-limiting, example embodiments as described herein.

FIG. 1a is a perspective view of a micro-heater according to example embodiments;

FIG. 1b is a plain view of the micro-heater shown in FIG. 1a;

FIG. 2a is a perspective view of a micro-heater array in which two micro-heaters according to example embodiments are connected in series;

FIG. 2b is a perspective view of a micro-heater array in which three micro-heaters according to example embodiments are connected in series;

FIGS. 3a to 3d illustrate a method for manufacturing a micro-heater array according to example embodiments including side views (FIGS. 3a, 3c, 3d) and a plain view (FIG. 3b); and

FIG. 4 is an I-V graph showing each light emitting point depending on the widths (W3) of contact regions in individual micro-heaters of a micro-heater array according to example embodiments.

### DETAILED DESCRIPTION OF EXAMPLE EMBODIMENTS

Various example embodiments will now be described more fully with reference to the accompanying drawings in which some example embodiments are shown. In the drawings, the thicknesses of layers and regions may be exaggerated for clarity.

Detailed illustrative embodiments are disclosed herein. However, specific structural and functional details disclosed herein are merely representative for purposes of describing example embodiments. Example embodiments, however, may be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments.

Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” may encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, example embodiments may be embodied in many alternate forms and should not be construed as limited to only example embodiments set forth herein.

According to example embodiments, a micro-heater may be formed. A micro-heater array may include two or more micro-heaters. In the micro-heater or the micro-heater array, power consumed for driving the micro-heater or the micro-heater array may be decreased. The micro-heater may include a substrate, at least one heating element unit which is spaced apart from the substrate and has a configuration to allow two or more heating element units to be repeatedly connected in series, and a support structure between the substrate and the at least one heating element unit to support the at least one heating element unit at a lower part of the at least one heating element unit. The micro heater can also be defined to have a substrate, at least two heating element units provided on the substrate, the at least two heating element units being configured to connect in series, and a support structure between the substrate and each heating element unit to support each heating element unit at a lower part of each heating element unit. Two or more micro-heaters may be connected in series in order to form an array of the micro-heater by connecting two or more heating element units in series. At least two heating elements connected in series, may be connected in parallel as well. However, if two heating elements are directly connected in parallel without first being connected in series, a current value may be non-uniform depending upon the parts of the micro-heater array and the power consumption may increase as the power is divided into the micro-heater array.

However, by reducing a heat transfer area of a heat transfer region where heat transfer occurs between each heating element unit and each support structure, consumed driving power of the micro-heater or the micro-heater array may be decreased. This area, however, may only be decreased to a point where the support structure adequately supports each heating element unit. For example, this configuration allows the power consumed for driving the micro-heater or the micro-heater array to be decreased to a point where the area of the support structure is also decreased.

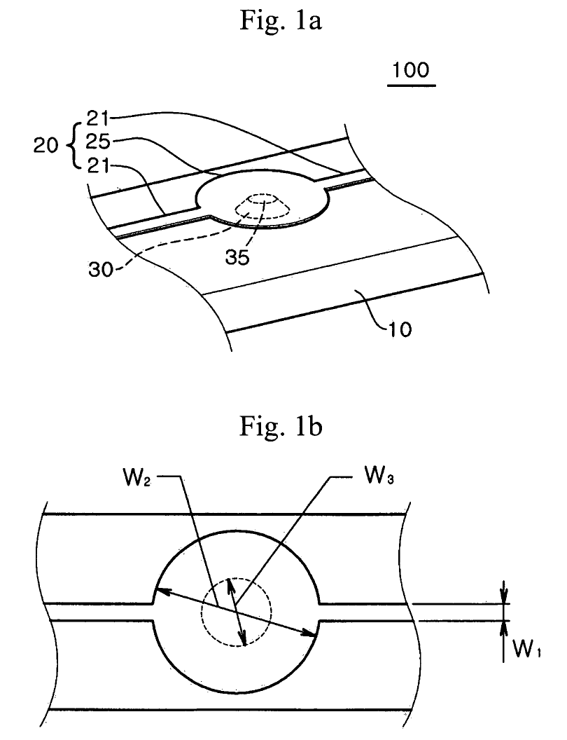

FIG. 1a is a perspective view of a micro-heater according to example embodiments, and FIG. 1b is a plain view of the micro-heater shown in FIG. 1a. Referring to FIG. 1a, a micro-heater 100 may include a substrate 10, one or more heating element unit 20, and a support structure 30 which supports the heating element unit 20 between the heating element unit 20 and the substrate 10.

The heating element unit 20 may have a shape and/or structure configured to where two or more of the heating element units 20 may be connected in series. Referring to FIG. 1a which shows an example embodiment of the heating element unit 20, the heating element unit 20 may have a symmetrical shape and/or structure that includes second region 25, which may be different than first regions 21, and where second region 25 is between first regions 21.

First regions 21 may have a bridge shape connecting a first region 21 to another first region 21 of another heating element unit 20. The second region 25 may have a circular shape supported by the support structure 30.

Two or more of the micro-heaters 100 may be repeatedly connected in series. The heating element unit 20 may be made of molybdenum, tungsten, silicone carbide and the like and may emit light and generate heat when power is applied thereto. The support structure 30 supports the heating element unit 20 at a lower part of the second region 25 of the heating element unit 20.

An area of a contact region 35, wherein the support structure 30 and the second region 25 supported by the support structure 30 contact each other, may be decreased. As the area of the contact region 35 becomes smaller, the heat transfer between the support structure 30 and the heating element unit 20 decreases as may the power that is consumed for driving the micro-heater 100.

The ideal size of the area of the contact region 35 would be zero. However, when the area of the contact region 35 is too small, supporting the heating element may become too difficult because of the decreased structural stability. Accordingly, the area of the contact region 35 may be regulated and/or determined to be the smallest area or relatively more, in which support for the heating element unit 20 may be maintained.

Referring to FIG. 1b, a width (W1) of the first region 21, a width (W2) of the second region 25 and a width (W3) of the contact region 35 are shown. In FIGS. 1a and 1b, the second region 25 and the contact region 35 have circular shapes. However, the second region 25 and/or the contact region 35 may have rectangular shapes or may have any other possible shape, depending on the etching process used. In each respective shape, the width refers to a horizontal length of the shape. Therefore, for the circular shape, the diameter is the width.

Regarding the widths of the respective regions, the width (W2) of the second region 25 may be larger than the width (W1) of the first region 21 in order to easily etch the support structure 30, and to more easily etch the contact region 35. In addition, the width (W1) of the first region 21 may be smaller than the width (W2) of the second region 25 in order that the light emitted and heat generated from the first region 21 may be more than that from the second region 25. Also, the location of where the light may be emitted and heat generated is adjustable.

As described above, according to example embodiments, the first 21 and second 25 regions of the heating element unit 20 are divided. The light emitted and heat generated in the first region 21 may be relatively higher than the light emitted and heat generated in the second region 25 supported by the support structure 30. The area where the heat transfer occurs in the second region 25 may be decreased. As a result, it is possible to reduce unnecessary power waste and to enable the applied power to be efficiently used for high temperature heating of the first region 21.

The width (W3) of the contact region 35 may be smaller than the width (W2) of the second region 25. Since the area of the contact region 35 may be decreased to a limit where supporting the heating element unit 20 may be maintained, the area of the contact region 35 may be smaller than that of the second region 25. Therefore, the width (W3) of the contact region 35 also may be smaller than the width (W2) of the second region 25.

As an example, suppose that the width (W2) of the second region 25 is the same as the width (W1) of the first region 21, in this example there may be no difference in light emission and heat generation between the parts of the heating element unit 20. Therefore, the heat transfer area should be relatively small but still support the heating element unit 20 and the support structure 30 having a small contact region 35 area may be formed to be substantially linear along the longitudinal direction at a center of the width of the heating element unit 20.

The width (W3) of the contact region 35 may be 0.1˜100 μm. When the width (W3) of the contact region 35 is more than 100 μm, the heat transfer area becomes large, so the power reduction effect may decrease. When the width (W3) of the contact region 35 is less than 0.1 μm, the support 30 may be difficult to form. The width (W3) of the contact region 35 may be 2˜3 μm in order to reduce power and maintain the support of the heating element unit 20. The width (W2) of the second region 25 may be 0.1˜100 μm and the width (W1) of the first region 21 may be 0.1˜30 μm.

The substrate may be made of glass, plastic, and similar insulating materials, rather than a silicon wafer. A silicon wafer may absorb the radiant heat (visible or infrared spectrum) during heating and may thus break, so high temperature heating becomes difficult. However, glass transmits radiant heat, so that high temperature heating is possible. Therefore, a glass substrate allows high temperature heating and may be suitable for a micro-heater or a micro-heater array. In a micro-heater or a micro-heater array, local heating of 600˜2,000° C. may be performed while the temperature of the glass substrate may be maintained at 50° C. or less.

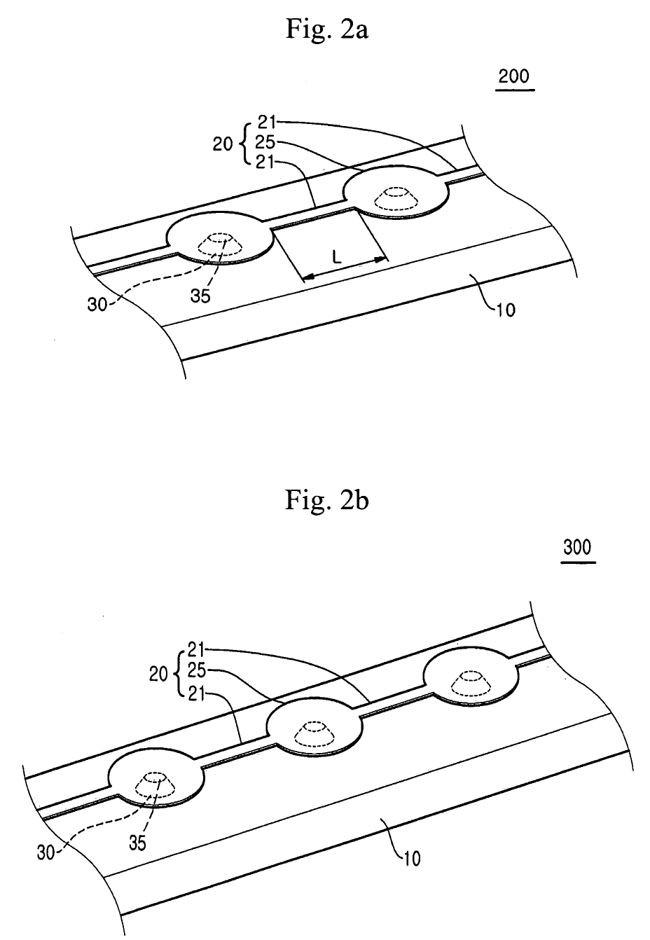

FIG. 2a is a perspective view of a micro-heater array in which two micro-heaters according to example embodiments are connected in series, and FIG. 2b is a perspective view of a micro-heater array in which three micro-heaters according to example embodiments are connected in series. As shown in FIGS. 2a and 2b, two or more of the heating element units 20 are connected to each other so that the first regions 21 becomes a bridge between the second regions 25 of the two heating element units 20. Referring to FIG. 2a, a length of the bridge, which is indicated as L, may be 5˜150 μm.

As shown in FIGS. 2a and 2b, two or more of the micro-heaters may be connected in series to form a micro-heater array, so that power consumption may decrease. The micro-heater array may exhibit a stable shape even after the micro-heater array is heated to 1,500° C. or higher. Also at least two micro-heaters connected in series, may be connected in parallel as well.

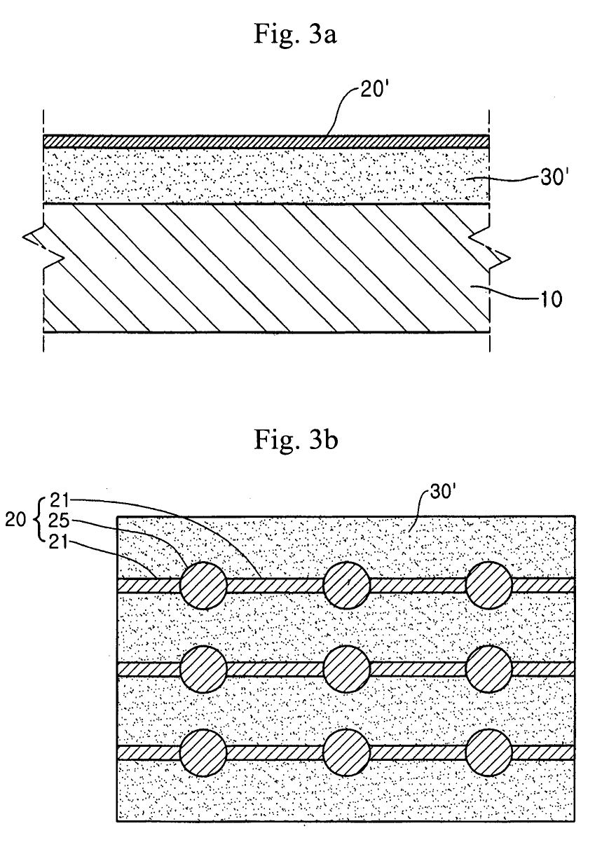

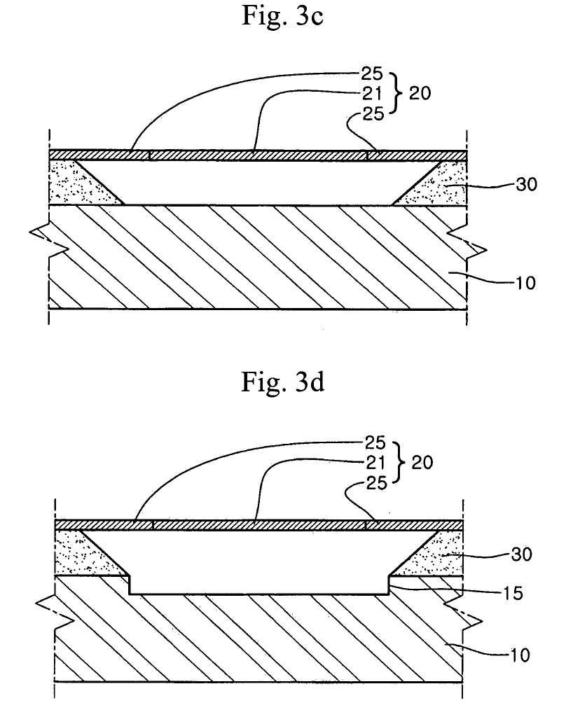

FIGS. 3a to 3d illustrate a method for manufacturing a micro-heater array according to example embodiments with side views (FIGS. 3a, 3c, 3d) and a plain view (FIG. 3b). Referring to FIG. 3a, a heating element layer 20′ is formed on a substrate 10, a sacrificial layer 30′, which will be etched to form support structure 30, is formed between the heating element layer 20′ and the substrate 10. Referring to FIG. 3b, the heating element layer 20′ is patterned so that two or more of the heating element units 20 which, for example, have first regions 21 and a second region 25 between the first regions 21 are connected in series to form an array.

Referring to FIG. 3c, the sacrificial layer 30′ is etched off so that the sacrificial layer has a shape of support structure 30. The etching is performed to reduce an area of a contact region 35 between the support structure 30 and the heating element unit 20. Referring to FIG. 3d, the substrate 10 between the support structures 30 may be further etched at an area 15 between the support structures, if required.

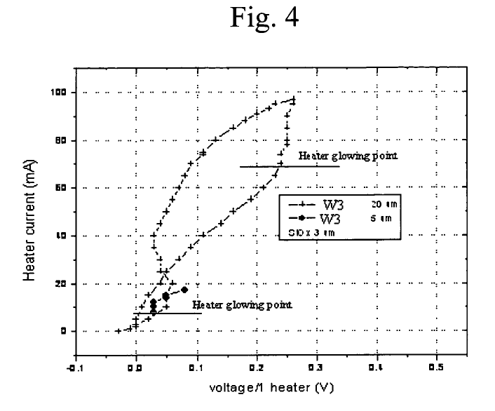

FIG. 4 is an I-V graph showing each light emitting point depending on widths (W3) of contact region 35 in individual heating element units 20 of the micro-heater arrays according to example embodiments. FIG. 4 shows that the light emitting points are different depending on the widths (W3) of contact region 35 of the support structure 30. For example, comparing the power consumption which is obtained from the heater current multiplied by voltage per heater in each light emitting point, the power consumption where the width (W3) of the contact region 35 is relatively small (5 μm) is less than the power consumption where the width (W3) of the contact region 35 is relatively large (20 μm).

An example embodiment includes a total of 751 micro-heaters arranged to form an array. In the array, a length (L) was 30 μm and a width (W1) was 10 μm. Further, a width (W2) was 30 μm and a width (W3) was 3 μm. The entire size of the array was 4.5×1.3 mm. The power consumption was 0.07 W (7 mA×10V).

A micro-heater or a micro-heater array according to example embodiments may be applied to a variety of electronic devices, in particular large-scaled electronic devices because the power consumption is low. In addition, a micro-heater or a micro-heater array may be manufactured at a low cost. Further, a micro-heater or a micro-heater array may be integrated in a chip on glass (COG) or system on glass (SOG), and also may be applied to directly synthesize nano-materials or to modify the various materials on the glass.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

What is claimed is:

1. A micro-heater comprising:
a substrate;
at least one heating element unit on the substrate, the at least one heating element unit having a configuration to allow two or more heating element units to be repeatedly connected in series; and
a support structure formed between the substrate and the at least one heating element unit to support the at least one heating element unit at a lower part of the at least one heating element unit.

2. The micro-heater according to claim 1, wherein, two or more heating element units are connected in series to form an array of the micro-heater.

3. The micro-heater according to claim 1, wherein,
the at least one heating element unit has first regions and a second region having a width larger than that of the first regions,
the second region is between the first regions,
the support structure supports the at least one heating element unit at a lower part of the second region of the at least one heating element unit, and
an area of a contact region between the support structure and the at least one heating element unit is equal to or less than an area of the second region.

4. The micro-heater according to claim 1, wherein the substrate is made of glass.

5. An electronic device comprising the micro-heater according to claim 1.

6. The micro-heater according to claim 2, wherein the substrate is made of glass.

7. An electronic device comprising the array of micro-heaters according to claim 2.

8. The micro-heater according to claim 3, wherein, two or more heating element units are connected in series to form an array of the micro-heater.

9. A method for manufacturing a micro-heater comprising:
forming a sacrificial layer on a substrate and forming a heating element layer on the sacrificial layer;
patterning the heating element layer to form at least one heating element unit, wherein the at least one heating element unit has a configuration to allow two or more heating element units to be repeatedly connected in series; and
etching the sacrificial layer to form a support structure to support the at least one heating element unit at a lower part of the at least one heating element unit.

10. The method according to claim 9, wherein the heating element layer is patterned so that two or more heating element units are connected in series to form a micro-heater array.

11. The method according to claim 9, wherein an area of a contact region between the support structure and the at least one heating element unit is decreased while still maintaining support of the at least one heating element unit.

12. The method according to claim 9, wherein heat transfer between the support structure and the at least one heating element unit is decreased.

13. The method according to claim 9, wherein,
the at least one heating element unit has first regions and a second region having a width larger than that of the first regions,
the second region is between the first regions,
the support structure is formed to support the at least one heating element unit at a lower part of the second region of the at least one heating element unit, and
an area of a contact region between the support structure and the at least one heating element unit is equal to or less than an area of the second region.

14. The method according to claim 10, wherein an area of a contact region between the support structure and the at least one heating element unit is decreased while still maintaining support of the at least one heating element unit.

15. The method according to claim 10, wherein heat transfer between the support structure and the at least one heating element unit is decreased.

16. The method according to claim 10, wherein,
the at least one heating element unit has first regions and a second region having a width larger than that of the first regions,
the second region is between the first regions,
the support structure is formed to support the at least one heating element unit at a lower part of the second region of the at least one heating element unit, and
an area of a contact region between the support structure and the at least one heating element unit is equal to or less than an area of the second region.
